(19) United States
(12) Patent Application Publication
(10) Pub. No.: US 2010/0247200 A1
(43) Pub. Date: Sep. 30, 2010

(54) RECORDING MEDIUM TRANSPORTING DIRECTION SWITCHING MECHANISM, FIXING DEVICE AND IMAGE FORMING APPARATUS

(76) Inventor: Yukihiro Ichiki, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 12/627,398

(22) Filed: Nov. 30, 2009

(30) Foreign Application Priority Data
Mar. 27, 2009 (JP) 2009-080563

(51) Int. Cl. G03G 15/20; B65H 5/36

(52) U.S. Cl. 399/400; 271/225

(57) ABSTRACT

A recording-medium-transporting-direction-switching-mechanism including a transport-unit transporting the recording-medium in one/another directions; a guiding-unit rotatably supported and one-end-portion being provided to be capable of existing in a transport-path, the guiding-unit being rotated by a leading-end-portion of the recording-medium transported toward the transport-unit contacting the guiding-unit, and rotating in a reverse-direction after a trailing-end-portion of the recording-medium transported by the transport-unit in the one-direction passes therethrough, and guiding the recording-medium transported by the transport-unit in the other-direction after the trailing-end-portion of the recording-medium passes therethrough, the one-end-portion of the guiding-unit having substantially rectanglular-shape, and a direction in which the leading-end-portion of the recording-medium transported toward the transport-unit is directed intersecting at an acute angle with a surface of the guiding-unit against which the leading-end-portion of the recording-medium contacts; and a detecting-unit that detects a state where the recording-medium is passing through the guiding-unit by rotating integrally with the guiding-unit, is provided.

### CROSS-REFERENCE TO RELATED APPLICATION

This application is based on and claims priority under 35 USC 119 from Japanese Patent Application No. 2009-080563 filed Mar. 27, 2009.

### BACKGROUND

### Technical Field

The present invention relates to a recording medium transporting direction switching mechanism, a fixing device and an image forming apparatus.

### SUMMARY

A recording medium transporting direction switching mechanism according to an aspect of the present invention includes: a transport unit that is provided in a transport path of a recording medium and that transports the recording medium in one direction and in the other direction; a guiding unit that is rotatably supported and whose one end portion is provided so as to be capable of existing in the transport path, the guiding unit being rotated by a leading end portion of the recording medium transported toward the transport unit contacting the guiding unit, and rotating in a reverse direction after a trailing end portion of the recording medium transported by the transport unit in the one direction passes therethrough, and that guides the recording medium transported by the transport unit in the other direction after the trailing end portion of the recording medium passes therethrough, the one end portion of the guiding unit being formed substantially into a rectangular shape when seen from a side, and a direction in which the leading end portion of the recording medium transported toward the transport unit is directed intersecting at an acute angle with a surface of the guiding unit against which the leading end portion of the recording medium contacts; and a detecting unit that detects a state in which the recording medium is passing through the guiding unit by rotating integrally with the guiding unit.

### BRIEF DESCRIPTION OF THE DRAWINGS

Exemplary embodiments of the invention will be described in detail with reference to the following figures, wherein:

FIG. 1 is a schematic side view of an image forming apparatus according to an exemplary embodiment of the present invention;

FIG. 2 is a side view that schematically shows a fixing device immediately before a leading end portion of a recording medium hits against a guiding unit;

FIG. 3 is a side view that schematically shows a fixing device immediately before a trailing end portion of a recording medium passes through a guiding unit;

FIG. 4 is a side view that schematically shows a fixing device immediately after a trailing end portion of a recording medium passes through a guiding unit and is guided to a reversal portion;

FIG. 5 is a perspective view that schematically shows a fixing device before a leading end portion of a recording medium hits against a guiding unit;

FIG. 6 is a perspective view that schematically shows a fixing device when a recording medium is in the process of passing through a guiding unit;

FIG. 7 is a side view that schematically shows a fixing device before a leading end portion of a recording medium hits against a guiding unit;

FIG. 8 is a side view that schematically shows a fixing device when a recording medium is in the process of passing through a guiding unit;

FIG. 9 is a side view that schematically shows a fixing device after a leading end portion of a recording medium hits against a guiding unit of a comparative example; and

FIG. 10 is a side view that schematically shows a fixing device immediately before a trailing end of a recording medium passes through a guiding unit of a comparative example.

### DETAILED DESCRIPTION

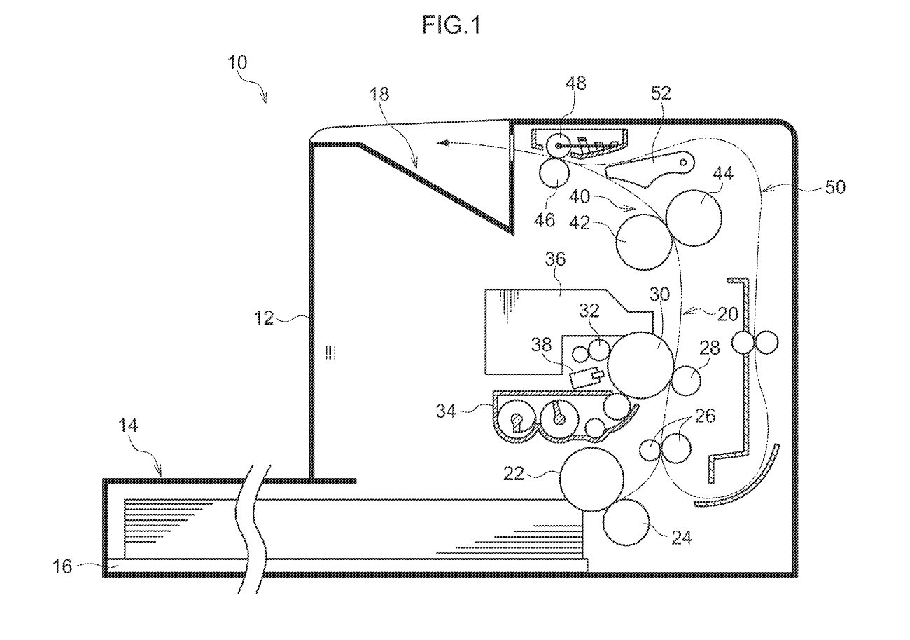

Exemplary embodiments of the present invention are hereinafter described on the basis of examples illustrated in the figures. As shown in FIG. 1, an image forming apparatus 10 includes an image forming apparatus main body 12, and a paper feed unit (an example of an accommodating unit) 14 in which a recording sheet (an example of recording medium) P is accommodated is disposed at a lower portion of the image forming apparatus main body 12. Then, a paper discharge unit (an example of a discharge unit) 18 from which the recording sheet P with a toner image (an image) being fixed thereon is discharged, is formed at an upper portion of the image forming apparatus main body 12.

The paper feed unit 14 includes a sheet cassette 16 in which a large number of recording sheets P are laminated and accommodated, and a feed roller 22 is disposed in an upper portion of the sheet cassette 16 at its one end side (in FIG. 1, at the rightward side of the sheet cassette). A retard roller 24 is provided so as to face the feed roller 22.

Accordingly, the recording paper P located at the uppermost position of the sheet cassette 16 is taken out by the feed roller 22, and handled by cooperation of the feed roller 22 and the retard roller 24, and further delivered to a transport path 20. The recording sheet P delivered to the transport path 20 stops temporarily by a registration roller 26 disposed further at the upstream side in the sheet transporting direction than a photoreceptor 30, and is sequentially transported toward the photoreceptor 30.

The photoreceptor 30 configuring a transfer member is supported in a rotatable manner. Provided around the photoreceptor 30 are a charging roller 32 that charges the photoreceptor 30 uniformly, a development device 34 that develops a latent image formed on the photoreceptor 30 with a toner (developer), and a cleaning device 36 that removes the toner remaining on the surface of the photoreceptor 30 after transfer of a toner image.

A light writing device 38 is disposed between the charging roller 32 and the development device 34. Due to the surface of the photoreceptor 30 being irradiated with light, a latent image comes to be formed on the surface of the photoreceptor 30. A backup roller 28 configuring a transfer member is disposed so as to face the photoreceptor 30 with the transport path 20 interposed therebetween.

Further, a fixing device 40 is provided further at the downstream side in the sheet transporting direction than the photoreceptor 30 and the backup roller 28. In the fixing device 40, a heat roller (an example of a fixing member) 42 and a press roller (an example of the fixing member) 44 are disposed so as to face each other, and the recording sheet P on which an unfixed toner image is transferred is nipped and transported by the heat roller 42 and the press roller 44 from the lower side to the upper side. In this manner, the unfixed toner image is fixed on the recording sheet P.

A discharge roller (an example of a transporting member) 46 and a pinch roller set (an example of a transporting member) 48 are disposed so as to face each other at the downstream side of the heat roller 42 and the press roller 44 of the fixing device 40 in the sheet transporting direction. Accordingly, the recording sheet P on which a toner image is fixed is discharged onto the paper discharge unit 18 by being nipped and transported by the discharge roller 46 and the pinch roller set 48 while curling of the recording sheet toward the side of the heat roller 42 (toward the surface to be printed) is being straightened (reduced).

In the fixing device 40, the heat roller 42 and the discharge roller 46 are disposed at the lower side, and the press roller 44 and the pinch roller set 48 are disposed at the upper side. Further, provided in the transport path 20 between “the heat roller 42 and the press roller 44” and “the discharge roller 46 and the pinch roller set 48” is a reversal gate 52 (an example of a guiding unit) that guides the recording paper P to the reversal unit 50 when both surfaces of the recording sheet P are printed.

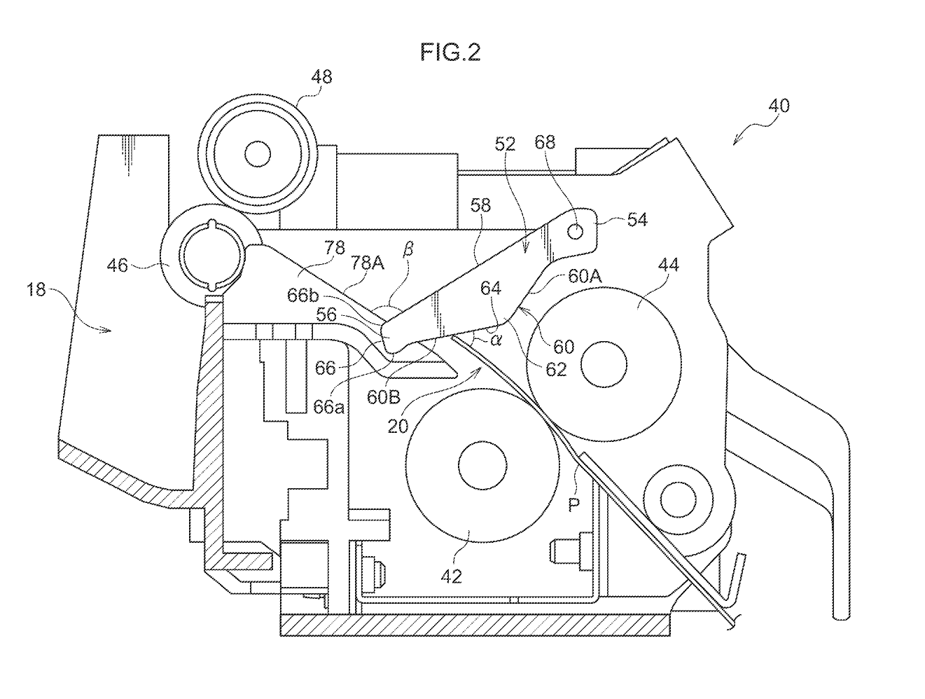

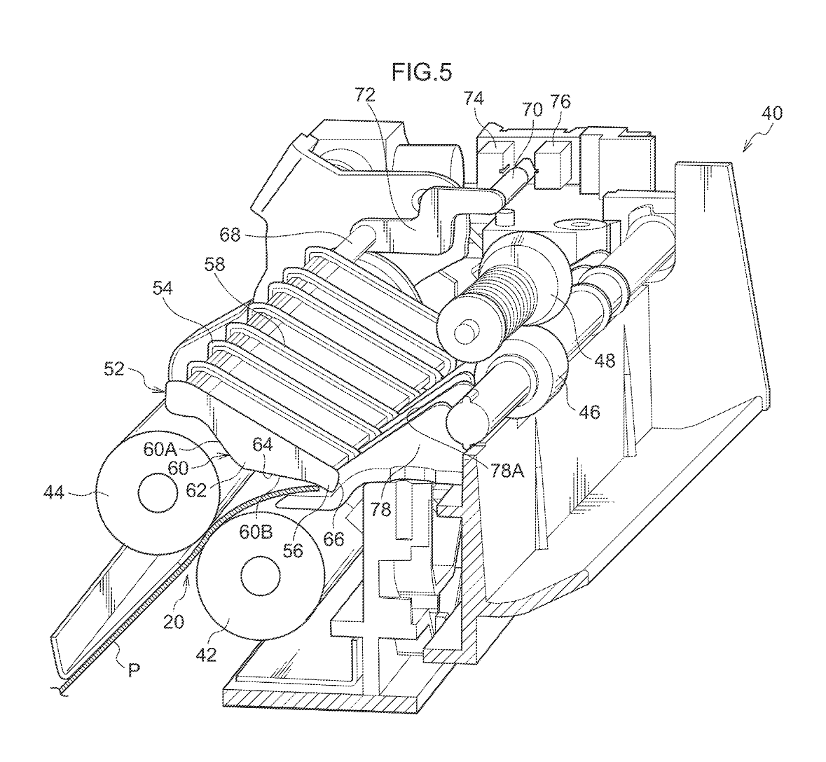

The reversal gate 52 is, as shown in FIG. 2 and FIG. 5, disposed such that the longitudinal direction thereof is along the sheet widthwise direction with having a comb-like tooth shape. A one end portion 56 of the reversal gate 52 is made to extend so as to be able to exist in the transport path 20 when the recording sheet P does not pass through the reversal gate 52. The other end portion 54 of the reversal gate 52 is fixed on a rotating shaft 68 that is supported in a rotatable manner at a position above the press roller 44.

Further, the one end portion 56 of the reversal gate 52 is formed so as to have a substantially rectangular configuration when seen from the side, that is, seen from the axial direction of the rotating shaft 68 (seen from a direction which is a widthwise direction of the recording sheet P and is orthogonal to a transporting direction of the recording sheet P). That is to say, the one end portion 56 is formed substantially into a rectangle by a lower side corner portion 66a that forms a corner portion at the side of the lower end portion 60B (described later) of the reversal gate 52 and an upper side corner portion 66b that forms a corner portion at the side of the upper end surface 58 (described later) of the reversal gate 52.

The lower side corner portion 66a and the upper side corner portion 66b are each an corner portion, but the tip end portion thereof may be formed as a curved surface, and in this case, the lower side corner portion 66a and the upper side corner portion 66b are corner portions whose curvatures are larger than those of a lower end portion 60B, an upper end portion 58 and a leading end surface 66 (described later). It can be said that the lower side corner portion 66a and the upper side corner portion 66b are an upstream corner portion which is at the upstream side in the transporting direction of the recording sheet P and a downstream corner portion which is at the downstream side in the transporting direction of the recording sheet P, respectively.

Further, the lower side corner portion 66a is formed such that, in the state in which the recording sheet P does not make to rotate the reversal gate 52, that is, in the state in which the recording sheet P does not pass through the reversal gate 52, the lower side corner portion 66a is positioned further at the side to which the recording sheet P is transported and comes thereat than the upper side corner portion 66b, that is, at the side opposite to a side at which the discharge roller 46 and the pinch roller 48 are disposed.

Moreover, the lower side corner portion 66a is formed such that, in the state in which the recording sheet P makes to rotate the reversal gate 52, that is, in the state in which the recording sheet P is passing through the reversal gate 52, the lower side corner portion 66a is positioned further at the side at which the recording sheet P is transported and goes therefrom than the upper side corner portion 66b, that is, at the side of the discharge roller 46 and the pinch roller 48. Or, the lower side corner portion 66a is positioned at the same position of the upper side corner portion 66b in the horizontal direction (the direction parallel to the surface at which the image forming apparatus is installed).

In the present exemplary embodiment, in the state in which the recording sheet P is passing through the reversal gate 52, the lower side corner portion 66a is located substantially at the same position as that of the upper side corner portion 66b. That is to say, the leading end surface 66 of the reversal gate 52 is formed into a substantially vertical surface extending substantially in the vertical direction in the state in which the recording sheet P is passing through the reversal gate 52. In the reversal gate 52, the length of the leading end surface (described later) 66 is the shortest among the leading end surface 66, the lower end portion 60B and the upper end portion 58.

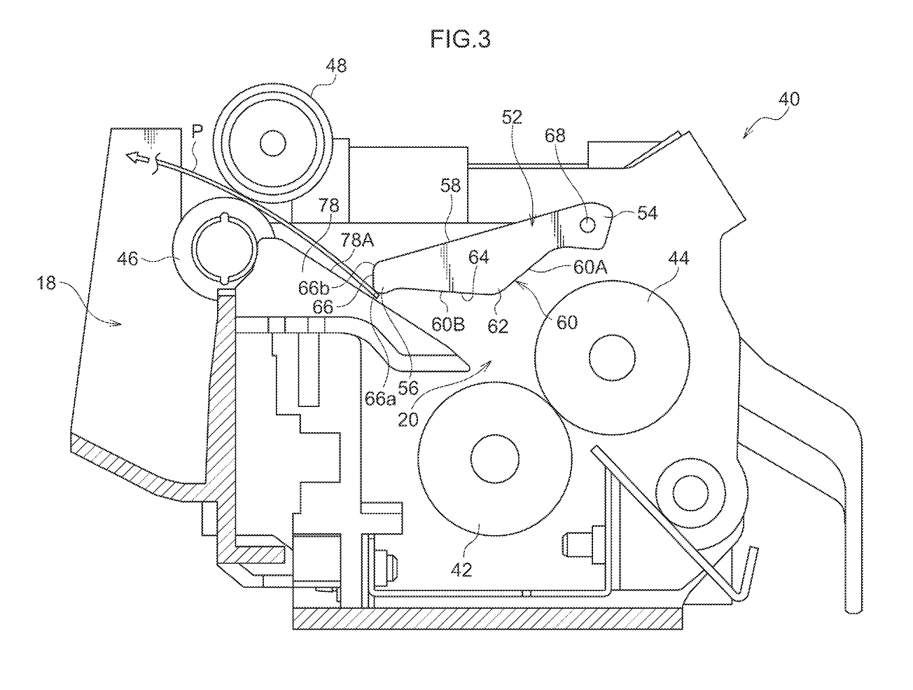

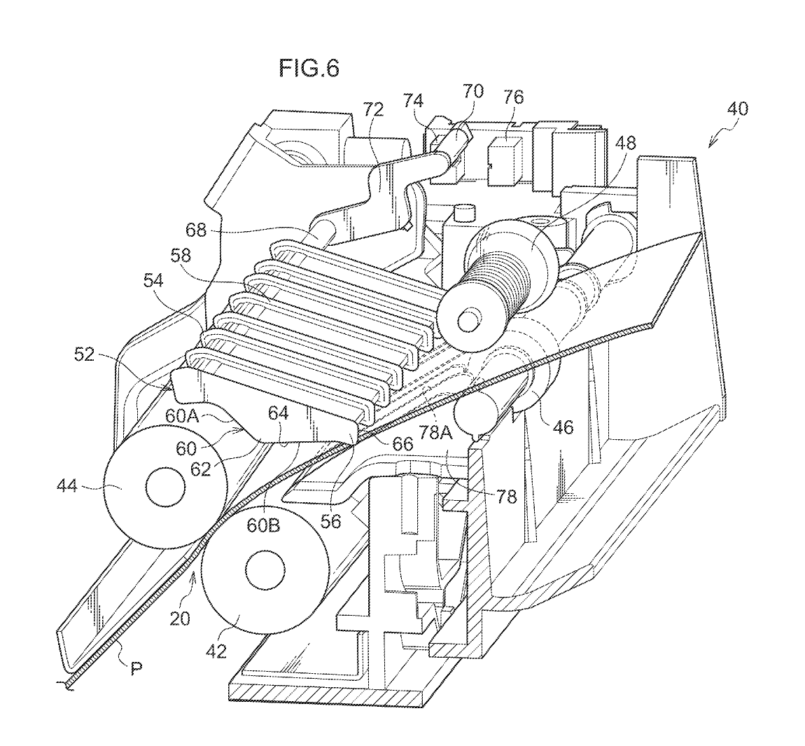

As shown in FIG. 3 and FIG. 6, the reversal gate 52 is rotated upward by the one end portion 56 thereof being pushed up by the recording sheet P that is nipped and transported by the heat roller 42 and the press roller 44. Then, after the recording sheet P passes through the reversal gate 52, the one end portion 56 of the reversal gate 52 moves back to its original position by rotating downward due to its own weight. In the case of performing double sided printing, the reversal gate 52 is adapted to guide, to the reversal unit 50, the recording sheet P that is nipped and transported by reverse rotation of the discharge roller 46 and the pinch roller 48.

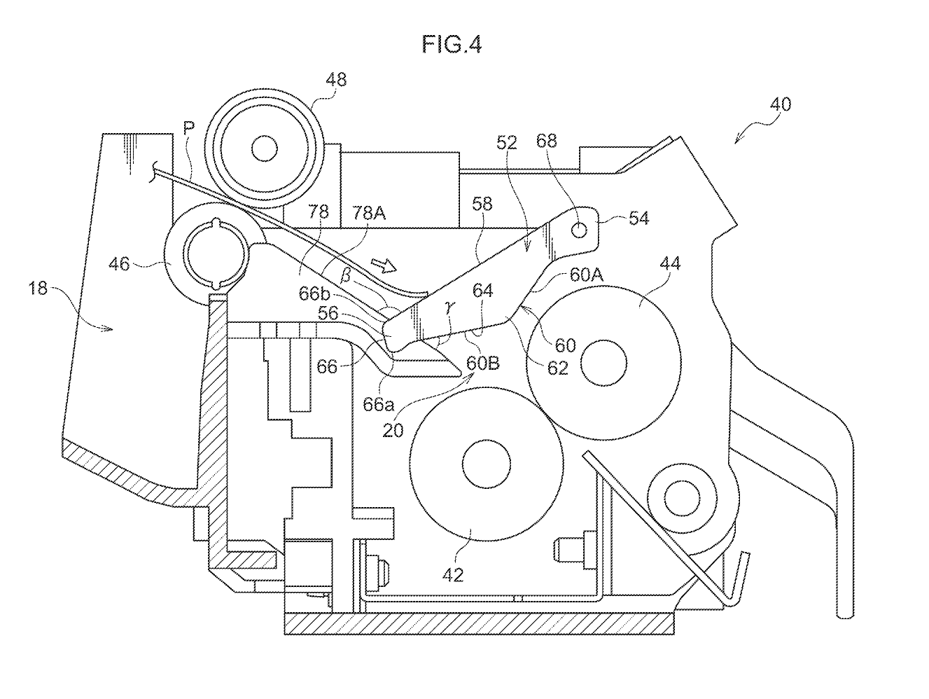

That is, as shown in FIG. 4, the recording sheet P which is to be subjected to double sided printing is guided by the upper end surface 58 of the reversal gate 52 and sent out toward the other direction, that is, in the direction toward the reversal unit 50.

The reversal gate 52 may be configured such that by using an elastic member such as a thread spring, a coil spring or the like (not shown in the drawings), it is being pressed so as to move back to its original position by the elastic member. Particularly, this structure becomes effective in a case which is different from the exemplary embodiment shown in FIG. 1, that is, in a case in which direction to which the recording sheet P passes and/or direction in which the reversal gate 52 is provided is set at the direction of being rotated at an angle of 90 degrees or 180 degrees from that of the exemplary embodiment.

Further, the lower end portion 60 of the reversal gate 52, that is from the one end portion 56 to the other end portion 54, is formed so as to project out (swell out) downward, and an intermediate portion 62 of the lower end portion 60 is formed as an obtuse-angled portion when seen from the side. That is to say, as shown in FIG. 2, in the state in which the recording sheet P does not come into contact with the reversal gate 52, a lower end portion 60A provided from the other end portion 54 to the intermediate portion 62 is formed so as to extend substantially right angles with respect to the transport path 20 (the recording sheet P), and the lower end portion 60B provided from the intermediate portion 62 to the one end portion 56 is formed so as to extend substantially in the horizontal (in a direction parallel to the plane on which the image forming apparatus 10 is installed).

Due to the aforementioned structure (due to the lower end portion 60 formed so as to swell out), the rigidity of the reversal gate 52 is secured. Further, when seen from the side as shown in FIG. 2, “a direction to which the leading end portion of the recording sheet P transported toward the discharge roller 46 and the pinch roller 48 is directed” and “the lower end surface 64 in the lower end portion 60B of the reversal gate 52 at which the leading end portion of the recording sheet P hits” are adapted to cross each other at an acute angle.

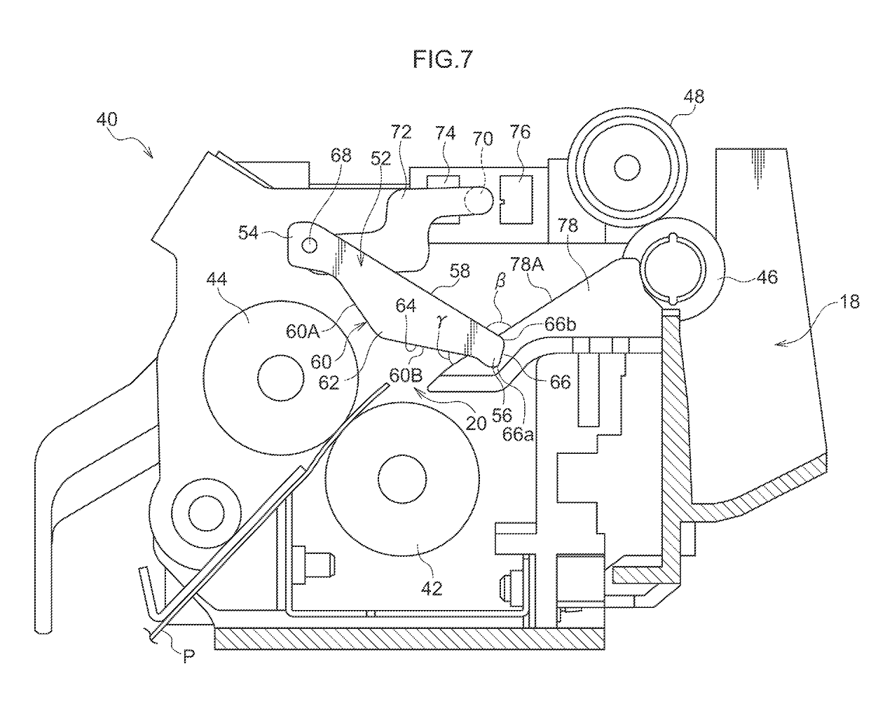

In other words, an angle α formed by “the lower end surface 64 in the lower end portion 60B, which is from the intermediate portion 62 to the one end portion 56, of the reversal gate 52” and “the transport path 20 of the recording sheet P (the recording sheet P)”, which angle is formed at the side of the other end portion 54 (which is at the upper surface side of the recording sheet P), becomes an acute angle. In the exemplary embodiment, the angle a is less than or equal to 75 degree, preferably, less than or equal to 60 degree. Incidentally, the angle α is similar (equal to) an angle γ formed by the lower end surface 64 of the reversal gate 52 and an upper end surface 78A of a guide member 78 when seen from the side as shown in FIG. 4 and FIG. 7.

Further, as shown in FIG. 2 and FIG. 3, the leading end surface 66 of the one end portion 56 of the reversal gate 52 when the recording sheet P passes through the reversal gate 52 is adapted to be directed toward further the discharge roller 46 side when seen from the side than the leading end surface 66 of the one end portion 56 of the reversal gate 52 when the recording sheet P does not pass through the reversal gate 52.

In other words, the leading end surface 66 at the one end portion 56 of the reversal gate 52 is formed so as to be oriented obliquely downward when the recording sheet P does not pass through (is not in the process of passing through) the reversal gate 52. To the contrary, when the recording sheet P passes through (is in the process of passing through) the reversal gate 52, the leading end surface 66 is formed so as to be oriented toward the paper discharge unit 18.

That is, in the state in which the recording sheet P pushes up the reversal gate 52, i.e., when the recording sheet P is in the process of passing through the reversal gate 52 (as shown in FIG. 3, immediately before at least the trailing end portion of the recording sheet P finishes passing through the reversal gate 52), as described above, the leading end surface 66 of the reversal gate 52 is formed into a substantially vertical surface extending substantially in the vertical direction.

Further, as shown in FIG. 5 through FIG. 8, the fixing device 40 is provided with a detecting portion (an example of a detecting unit) 70 that detects that the recording sheet P is in the process of passing through the reversal gate 52, by rotating integrally with the reversal gate 52. The detecting member 70 is provided to project from one end portion of a connecting member 72 having an S-shaped configuration when seen from the side in such a manner so as to extend outside in the axial direction of the rotating shaft 68 on which the reversal gate 52 is fixed, and the other end portion of the connecting member 72 is fastened to the rotating shaft 68.

The detecting member 70 is, as shown in FIG. 7, provided in a region between the press roller 44 and the pinch roller 48 along the transport path 20 of the recording sheet P when seen from the side. Further, in the fixing device 40, a light emitting portion 74 and a light receiving portion 76, which detect whether or not the detecting member 70 exists therebetween, are disposed to face each other at a predetermined interval therebetween.

Accordingly, when the recording sheet P does not push up the reversal gate 52, the detecting member 70 is interposed between the light emitting portion 74 and the light receiving portion 76 (refer to FIG. 5 and FIG. 7), and the state in which the recording sheet P does not pass through (is not in the process of passing through) the reversal gate 52 is detected.

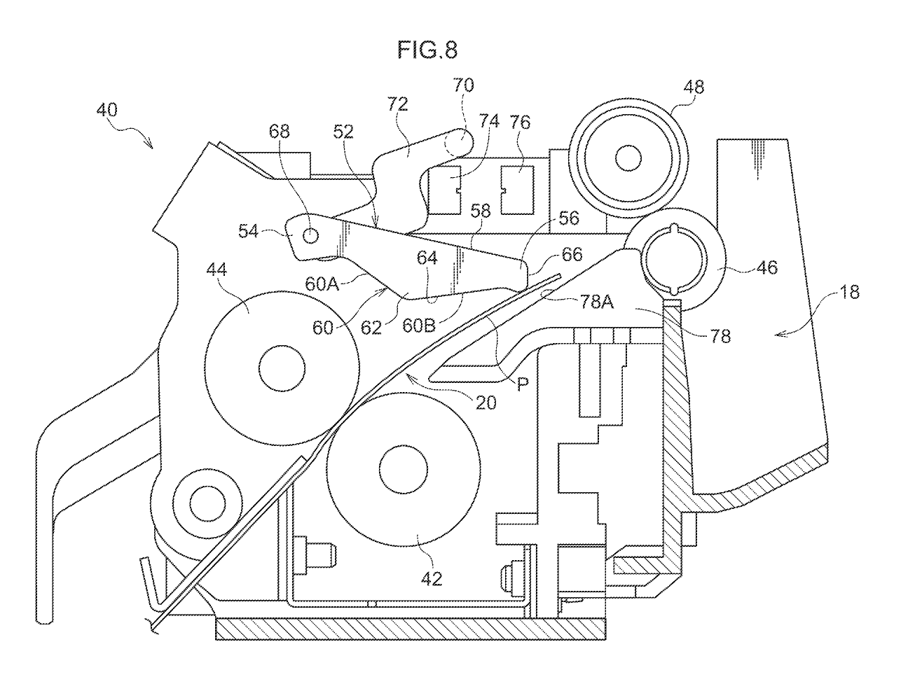

Then, when the recording sheet P pushes up the reversal gate 52, the detecting member 70 moves upward and is away from a region between the light emitting portion 74 and the light receiving portion 76 (refer to FIG. 6 and FIG. 8), and the state in which the recording sheet P passes through (is in the process of passing through) the reversal gate 52.

Further, as shown in FIG. 2 through FIG. 8, the guide member 78 that guides, to a region between the discharge roller 46 and the pinch roller 48, the recording sheet P nipped and transported by the heat roller 42 and the press roller 44, is disposed at the upstream side of the discharge roller 46 in the sheet transporting direction in such a manner that the longitudinal direction of the guide member 78 is along the sheet widthwise direction with having a comb-like tooth shape so as to engage with the one end portion 56 of the reversal gate 52.

When the recording sheet P does not pass through the reversal gate 52, the upper end surface (portion) 78A of the guide member 78 is structured so as to form an obtuse angle with the upper end surface 58 of the reversal gate 52 (such that the angle β formed by the upper end surface 78A of the guide member 78 and the upper end surface 58 of the reversal gate 52 becomes an obtuse angle).

The leading end surface 66 of the one end portion 56 of the reversal gate 52 in the state in which the recording sheet P does not pass through the reversal gate 52 is adapted to be away from a position in the transport path 20 (is adapted to be into the guide member 78) when seen from the side. Due to this structure, the leading end portion of the recording sheet P transported in the direction toward the reversal unit 50 (in the opposite direction) is prevented from being bent at the reversal gate 52.

In the image forming apparatus 10 having the aforementioned structure, the operation thereof is described hereinafter. First, the recording sheet P located at the uppermost position of the sheet cassette 16 is taken out by the feed roller 22, and sent out to the transport path 20 by being handled by cooperation of the feed roller 22 and the retard roller 24. Then, the recording sheet P sent out to the transport path 20 is sequentially transported by the registration roller 26 to the photoreceptor 30 side.

The surface (peripheral surface) of the photoreceptor 30 is in advance charged by the charging roller 32 uniformly. Then, the surface of the photoreceptor 30 is scanned with light irradiated from the light writing device 38, and a latent image based on image data is formed on the surface of the photoreceptor 30. Subsequently, the latent image is developed by the development device 34 with a toner, and a toner image (a visible image) is formed on the surface of the photoreceptor 30.

When the recording sheet P is nipped and transported by the photoreceptor 30 and the back-up roller 28, the toner image is transferred onto the surface of the recording sheet P, and the recording sheet P onto which an unfixed toner image is transferred is transported to the fixing device 40. Incidentally, after the toner image is transferred onto the recording sheet P, the surface of the photoreceptor 30 is subjected to cleaning processing by the cleaning device 36, and is made ready for subsequent image forming processing.

The transferred unfixed toner image is fixed on the recoding sheet P supplied to the fixing device 40 due to the recording sheet being nipped and transported by the heat roller 42 and the press roller 44. Immediately after nipping and transporting the recording sheet P by the heat roller 42 and the press roller 44 starts, the leading end portion of the recording sheet P hits against the lower end surface 64 of the reversal gate 52 (refer to FIG. 2).

At this time, the lower end surface 64 of the reversal gate 52 is disposed substantially in the horizontal position when seen from the side, and therefore, the leading end portion of the recording sheet P hits against the lower end surface 64 so as to form an acute angle therebetween (the former and the latter intersects with each other at an acute angle). That is to say, the lower end portion 60 of the reversal gate 52 is formed so as to swell out (the lower end portion 60 is made to swell out such that the intermediate portion 62 has an obtuse angle) such that angle a formed by the lower end surface 64 of the reversal gate 52 and the upper surface (of the leading portion) of the recording sheet P becomes an acute angle. Accordingly, the leading end portion of the recording sheet P hits against the reversal gate 52 at the early stage.

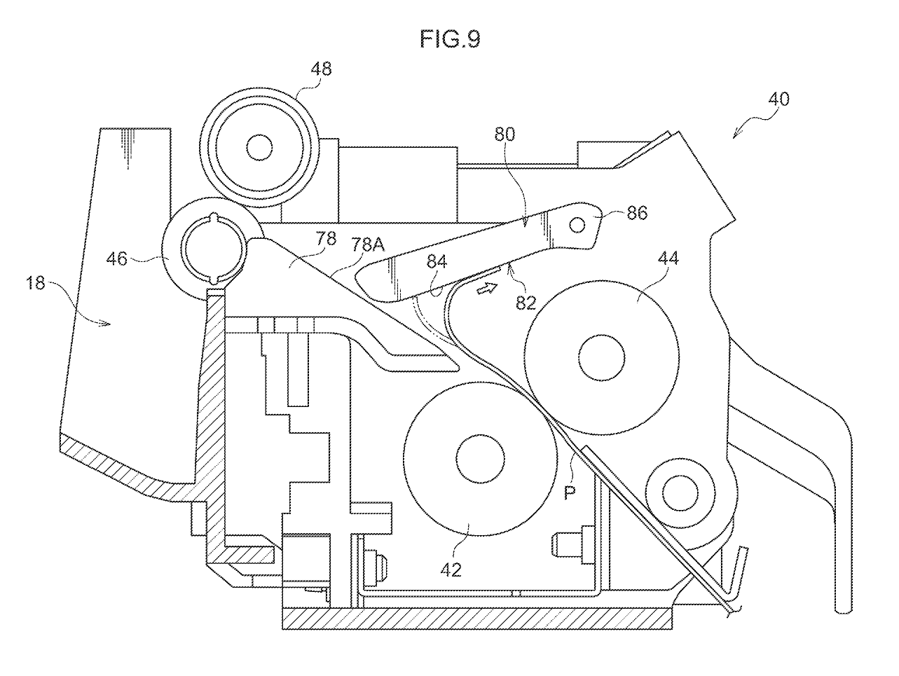

As in the case of a reversal gate 80 according to a comparative example shown in FIG. 9, when a lower end portion 82 of the reversal gate 80 is not formed so as to swell out, a distance (time) after the recording sheet P pass through the heat roller 42 and the press roller 44 until the recording sheet P hits against the reversal gate 80 becomes longer. In addition, there is a possibility that the leading end portion of the recording sheet P may be transported to the other end portion 86 side along a lower end surface 84 of the reversal gate 80. Consequently, there is a possibility that the leading end portion of the recording sheet may be damaged or paper jam may be caused.

To the contrary, in the reversal gate 52 according to the present exemplary embodiment, the lower end portion 60 is formed so as to swell out, and therefore, occurrence of the aforementioned problems is prevented. Thus, the leading end portion of the recording sheet P is made to hit against the reversal gate 52 at the early stage, and the reversal gate 52 is smoothly rotated upward (around the rotating shaft 68).

At the same time, the detecting member 70 fixed integrally with the reversal gate 52 moves away from the region between the light emitting portion 74 and the light receiving portion 76 to the upward direction, and therefore, the state in which the recording sheet P is in the process of passing through the reversal gate 52 is detected at the early stage, so the timing at which the recording sheet P is reversed is detected at the early stage.

In this manner, the recording sheet P which is nipped and transported by the heat roller 42 and the press roller 44 and on which a toner image is fixed is subsequently nipped and transported by the discharge roller 46 and the pinch roller 48. Then, when the trailing end portion of the recording sheet P finishes passing through the reversal gate 52, the reversal gate 52 is rotated downward due to its own weight.

When the recording sheet P passes through the reversal gate 52, the leading end surface 66 of the reversal gate 52 is oriented toward the paper discharge unit 18 side when seen from the side. That is to say, the leading end surface 66 of the reversal gate 52 in the state that the recording sheet P is in the process of passing through the gate is disposed to be a substantially vertical surface when seen from the side (refer to FIG. 3). Accordingly, the trailing end portion of the recording sheet P passes through the reversal gate 52 at the early stage, whereby the reversal gate 52 is rotated downward due to its own weight at the early stage.

In other words, in the state in which the recording sheet P does not rotate the reversal gate 52, that is to say, in the state in which the recording sheet P does not pass through the reversal gate 52, the lower side corner portion 66a is positioned further at the side to which the recording sheet P is transported to come thereat than the upper side corner portion 66b, that is, the lower side corner portion 66a is positioned at the side opposite to a side at which the discharge roller 46 and the pinch roller 48 are provided with respect to the upper side corner portion 66b. For this reason, the leading end portion of the transported recording sheet P early passes through the reversal gate 52. That is to say, the leading end portion of the recording sheet P early passes through the lower side corner portion 66a.

Further, in the state in which the recording sheet P rotates the reversal gate 52, that is, in the state in which the recording sheet P is passing through the reversal gate 52, the lower side corner portion 66a is positioned further at the side to which the recording sheet P is transported and goes therefrom than the upper side corner portion 66b, that is, the lower side corner portion 66a is positioned at the side at which the discharge roller 46 and the pinch roller 48 are provided with respect to the upper side corner portion 66b. Or, the lower side corner portion 66a is positioned at the same position as that of the upper side corner portion 66b in the horizontal direction (the direction parallel to the surface at which the image forming apparatus is installed). Therefore, the trailing end portion of the transported recording sheet P early passes through the reversal gate 52. That is to say, the trailing end of the recording sheet P early passes through the lower side corner portion 66a.

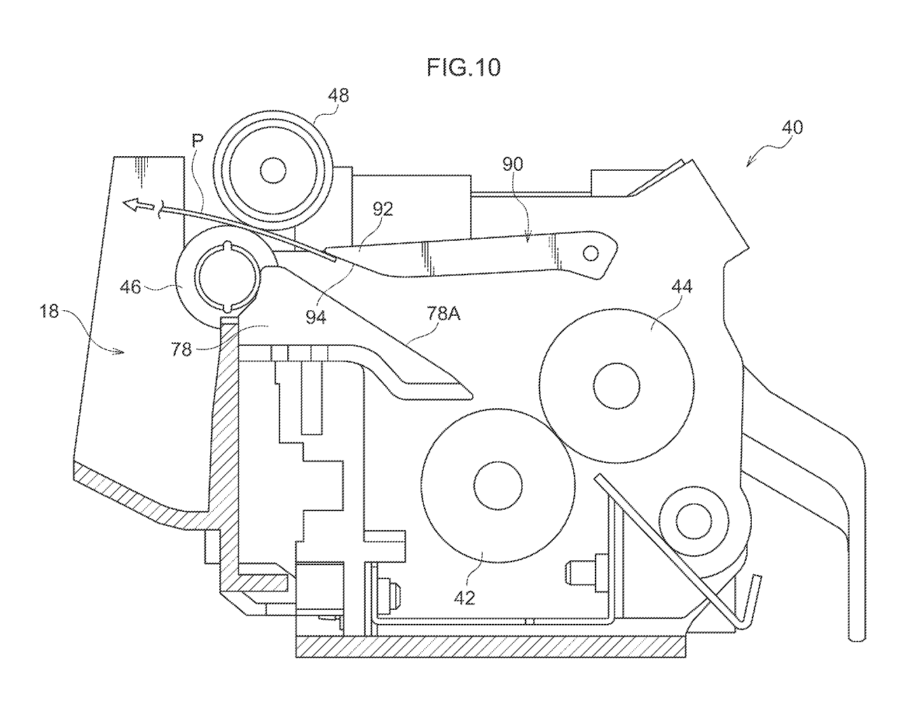

To the contrary, as shown in the case of a reversal gate 90 according to a comparative example shown in FIG. 10, a leading end surface 94 of one end portion 92 has a triangular configuration when seen from the side. In the state in which the recording sheet P passes through the reversal gate 90, the distance (time) of which the trailing end portion of the recording sheet P have passed through the reversal gate 90 becomes longer, and therefore the time until the reversal gate 90 rotates downward due to its own weight also becomes longer.

That is to say, in the reversal gate 90 according to the comparative example shown in FIG. 10, in the case in which both sides of the recording sheet P are printed, the distance of which the recording sheet P is nipped and transported by the discharge roller 46 and the pinch roller 48 toward the paper discharge unit 18 side becomes longer, and therefore the time until the recording sheet P is sent out to the reversal unit 50 also becomes longer, thereby resulting in deterioration of productivity.

In the reversal gate 52 according to the present exemplary embodiment, as described above, the recording sheet P passes through the gate 52 at the early stage and the reversal gate 52 can be rotated downward due to its own weight at the early stage. Therefore, in a case in which both sides of the recording sheet P are printed, the distance of which the recording sheet P is nipped and transported by the discharge roller 46 and the pinch roller 48 toward the paper discharge unit 18 side becomes short, and therefore the time until the recording sheet P is sent out to the reversal unit 50 becomes shorter, thereby resulting in improvement of productivity.

In this manner, due to the passing of the recording sheet P through the reversal gate 52 being finished, the reversal gate 52 rotates downward due to its own weight. However, in a case in which one side of the recording sheet P is printed, the recording sheet P is discharged onto the paper discharge unit 18 without being reversed. On the other hand, in a case in which both sides of the recording sheet P are printed, rotation of the discharge roller 46 and the pinch roller 48 temporarily stop, and subsequently, they rotate in a reverse direction, so as to send out the nipped recording sheet P to the reversal unit 50.

That is, the recording sheet P nipped by the discharge roller 46 and the pinch roller 48 is sent out to the reversal unit 50 along the upper end surface 58 of the reversal gate 52. At this time, the leading end surface 66 of the one end portion 56 of the reversal gate 52 is away from the position in the transport path 20 (end surface 66 of the one end portion 56 of the reversal gate 52 is positioned within the guide member 78), and the angle β formed by the upper end surface 58 and the upper end surface 78A of the guide member 78 is formed as an obtuse angle when seen from the side. Therefore, the recording sheet P is guided smoothly to the upper end surface 58 side (refer to FIG. 4) without being sent out toward the leading end surface 66 side (without the leading end portion of the recording sheet P being bent toward the leading end surface 66 side by the reversal gate 52).

Then, the recording sheet P sent out to the reversal unit 50 is transported again to the photoreceptor 30. When a toner image is transferred onto the back surface of the recording sheet, the recording sheet is transported to the fixing device 40 in the same manner as described above, and an unfixed toner image is fixed on the recording sheet. Subsequently, the recording sheet is nipped and transported by the discharge roller 46 and the pinch roller 48 and is discharged onto the paper discharge unit 18.

The recording medium transporting direction switching mechanism according to the present exemplary embodiment is described as above, but it is not limited to the examples illustrated in the figures. For example, the shape of the connecting member 72 that mounts the detecting member 70 may not be limited to the substantially S-shaped configuration when seen from the side.

Further, in the present exemplary embodiment, the leading end portion of the recording sheet P hits against the reversal gate 52 at the early stage and the trailing end portion of the recording sheet P passes through the reversal gate 52 at the early stage. This makes it possible to shorten the distance between “the heat roller 42 and the press roller 44” and “the discharge roller 46 and the pinch roller 48”. In addition, due to the detecting member 70 being provided in a region between the press roller 44 and the pinch roller 48 along the transport path 20, it suffices that the height of the detecting member 70 when rotating upward is low. Accordingly, reduction in the size of the fixing device 40 can be achieved, and consequently, reduction in the size of the image forming apparatus 10 can be achieved.

Furthermore, in the present exemplary embodiment, the configuration in which the reversal gate 52 is provided between “the fixing device” and “the discharge roller 46 and the pinch roller 48” is described above, but the invention is not limited to the same. The reversal gate 52 may also be provided at any place such as a rear surface, a bottom surface or the like of the image forming apparatus 10, as long as the reversal gate 52 is provided at the upstream side in the sheet transporting direction, with the recording sheet transported in one direction serving as the reference, with respect to a transport member such as a transport roller or a transport belt, which is capable of transporting the recording sheet P in one direction or in the other direction, the structure can also be applied.

What is claimed is:

1. A recording medium transporting direction switching mechanism, comprising:
a transport unit that is provided in a transport path of a recording medium and that transports the recording medium in one direction and in the other direction;
a guiding unit that is rotatably supported and whose one end portion is provided so as to be capable of existing in the transport path, the guiding unit being rotated by a leading end portion of the recording medium transported toward the transport unit contacting the guiding unit, and rotating in a reverse direction after a trailing end portion of the recording medium transported by the transport unit in the one direction passes therethrough, and that guides the recording medium transported by the transport unit in the other direction after the trailing end portion of the recording medium passes therethrough,
the one end portion of the guiding unit being formed substantially into a rectangular shape when seen from a side, and a direction in which the leading end portion of the recording medium transported toward the transport unit is directed intersecting at an acute angle with a surface of the guiding unit against which the leading end portion of the recording medium contacts; and
a detecting unit that detects a state in which the recording medium is passing through the guiding unit by rotating integrally with the guiding unit.

2. The recording medium transporting direction switching mechanism of claim 1, wherein a leading end surface of the one end portion of the guiding unit is directed further toward the transport unit when seen from the side when the recording medium is passing through the guiding unit than when the recording medium is not passing through the guiding unit.

3. The recording medium transporting direction switching mechanism of claim 1, wherein, when the recording medium is not passing through the guiding unit, the leading end surface of the one end portion of the guiding unit is positioned away from the transport path when seen from the side.

4. A fixing device comprising:
a fixing unit that nips and transports a recording medium onto which an unfixed image is transferred from a lower side to an upper side and fixes the unfixed image on the recording medium;
a transport unit that is provided at a downstream side of the fixing unit in a transporting direction of the recording medium, and
transports the recording medium in one direction and in the other direction;
a guiding unit that is rotatably supported at an upper position of the fixing unit and whose one end portion is provided so as to be capable of existing in the transport path, the guiding unit being rotated toward an upper side by a leading end portion of the recording medium transported toward the transport unit contacting the guiding unit, and rotating toward a lower side after a trailing end portion of the recording medium transported by the transport unit in the one direction passes therethrough, and that guides the recording medium transported by the transport unit in the other direction after the trailing end portion of the recording medium passes therethrough,
the one end portion of the guiding unit being formed substantially into a rectangular shape when seen from a side, and a direction in which the leading end portion of the recording medium transported toward the transport unit is directed intersecting at an acute angle with a surface of the guiding unit against which the leading end portion of the recording medium contacts; and
a detecting unit that detects a state in which the recording medium is passing through the guiding unit by rotating integrally with the guiding unit.

5. The fixing device of claim 4, wherein a leading end surface of the one end portion of the guiding unit is directed further toward the transport unit when seen from the side when the recording medium is passing through the guiding unit than the leading end surface of the one end portion of the guiding unit when the recording medium is not passing through the guiding unit.

6. The fixing device of claim 4, wherein the leading end surface of the one end portion of the guiding unit when the recording medium is not passing through the guiding unit is positioned away from the transport path when seen from the side.

7. The fixing device of claim 4, wherein the leading end surface of the one end portion of the guiding unit when the recording medium passes through the guiding unit becomes substantially vertical when seen from the side.

8. The fixing device of claim 4, wherein a lower end portion of the guiding unit between the one end portion and the other end portion is formed so as to project out toward a lower side when seen from the side.

9. The fixing device of claim 4, wherein the detecting unit is provided between the fixing unit and the transport unit along the transport path of the recording medium when seen from the side.

10. An image forming apparatus comprising:
an accommodating unit that accommodates a recording medium;
a transfer unit that transfers an unfixed image onto the recording medium sent from the accommodating unit;
the fixing device including:
a fixing unit that nips and transports a recording medium onto which an unfixed image is transferred from a lower side to an upper side and fixes the unfixed image on the recording medium;
a transport unit that is provided at a downstream side of the fixing unit in a transporting direction of the recording medium, and transports the recording medium in one direction and in the other direction;
a guiding unit that is rotatably supported at an upper position of the fixing unit and whose one end portion is provided so as to be capable of existing in the transport path, the guiding unit being rotated toward an upper side by a leading end portion of the recording medium transported toward the transport unit contacting the guiding unit, and rotating toward a lower side after a trailing end portion of the recording medium transported by the transport unit in the one direction passes therethrough, and that guides the recording medium transported by the transport unit in the other direction after the trailing end portion of the recording medium passes therethrough,
the one end portion of the guiding unit being formed substantially into a rectangular shape when seen from a side, and a direction in which the leading end portion of the recording medium transported toward the transport unit is directed intersecting at an acute angle with a surface of the guiding unit against which the leading end portion of the recording medium contacts; and
a detecting unit that detects a state in which the recording medium is passing through the guiding unit by rotating integrally with the guiding unit.
that fixes the unfixed image transferred by the transfer unit; and
a reversal unit in which the recording medium guided by the guiding unit is transported when performing double sided printing with respect to the recording medium.

11. The recording medium transporting direction switching mechanism of claim 1, wherein the one end portion of the guiding unit is formed substantially into the rectangular shape when seen from a direction which is a widthwise direction of the recording medium and is orthogonal to a transporting direction of the recording medium.

12. The fixing device of claim 4, wherein the one end portion of the guiding unit is formed substantially into the rectangular shape when seen from a direction which is a widthwise direction of the recording medium and is orthogonal to a transporting direction of the recording medium.
